(19) United States
(12) Patent Application Publication
(10) Pub. No.: US 2025/0124837 A1
(43) Pub. Date: Apr. 17, 2025

(54) AMBIANCE STYLE ADAPTATION OF DIFFERENT PORTIONS OF AN ADAPTIVE DISPLAY DEVICE IN A SURFACE DISPLAY CONFIGURATION

(71) Applicant: MOTOROLA MOBILITY LLC, WILMINGTON, DE (US)

(72) Inventors: AMIT KUMAR AGRAWAL, BANGALORE (IN); BILL RYAN, LIBERTYVILLE, IL (US); MARK D. FINNEY, CHICAGO, IL (US); JAMES SLOSS, CHICAGO, IL (US)

(21) Appl. No.: 18/488,362

(22) Filed: Oct. 17, 2023

(51) Int. Cl. G09G 3/00; G06F 3/01; G06F 3/03; G09G 3/3225; H04M 1/02; H04M 1/72451

(52) U.S. Cl. CPC G09G 3/035; G06F 3/011; G06F 3/0304; H04M 1/0241; H04M 1/0268; H04M 1/0283; H04M 1/72451; G09G 3/3225; G09G 2340/0464; G09G 2354/00

(57) ABSTRACT

An electronic device enables techniques for ambience style adaptation of different portions of an adaptive display device in a surface support configuration. The device includes a flexible electronic display, that is mounted in a flexible enclosure that enables the display to be bent into a configuration for use in a surface support configuration, such as standing on a desk or table. The device further includes a processor communicatively coupled to the electronic display, and which obtains context data from one or more data sources, wherein the context data is associated with one or more of a user and an environment surrounding the electronic device, and determines a device context. Based on the device context, a customization display theme for the electronic device is loaded, and the customization display theme is presented on the display of the electronic device.

### BACKGROUND

### 1. Technical Field

The present disclosure generally relates to portable electronic devices, and more specifically to portable electronic devices that support customization.

### 2. Description of the Related Art

Modern smartphones and tablet computers are equipped with high-resolution displays, as well as integrated digital cameras that capture high quality still pictures and videos. In addition to the camera and video features, smartphones can provide myriad other features. The features can include communication features, such as sending text messages and making voice calls. Additionally, the features can include engaging in social networking activities, internet browsing, navigation and mapping, online shopping, health and fitness, gaming, and more. As modern smartphones are useful for much more than voice calls, people often take their smartphones with them everywhere they go. Accordingly, a smartphone can also serve as an accessory for users in a wide variety of settings and activities. Décor enhances the visual appeal of a room, and can the tone and style of the space, making the space visually pleasing and inviting. Well-chosen decor elements can turn an ordinary room into an extraordinary one. Furthermore, décor allows individuals to express their personality, tastes, and interests. That is, décor provides a way for individuals to showcase their unique style and create a space that reflects their identity.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1 depicts an example component makeup of a communication device with specific components used to enable the device to perform functions for ambiance style adaptation of different portions of an adaptive display device in a surface support configuration, according to one or more embodiments;

FIG. 2A shows an example display of an electronic device that has been logically partitioned to provide two asymmetrical logical display partitions, according to one or more embodiments;

FIG. 2B shows an example display of an electronic device that has been logically partitioned to provide two symmetrical logical display partitions, according to one or more embodiments;

FIG. 2C shows an example display of an electronic device configured to include three logical display partitions, according to one or more embodiments;

FIG. 3 shows a system that includes a device having a flexible electronic device and communicatively coupled to an auxiliary computing device, according to one or more embodiments;

FIG. 4 illustrates a flexible, deformable, electronic device in a stand configuration, rendering a décor image, according to one or more embodiments;

FIG. 5 illustrates a flexible electronic device in a tent configuration, according to one or more embodiments;

FIG. 6 shows an example usage of a flexible electronic device in a tent configuration, according to one or more embodiments;

FIG. 7 illustrates a flexible electronic device in a wearable configuration, according to one or more embodiments;

FIG. 8 depicts a flowchart of a method for presenting a customization display theme on a logically partitioned region of the display of an electronic device based on context data, according to one or more embodiments; and

FIG. 9 depicts a flowchart of a method for rendering an image corresponding to identified characteristics that at least partially correspond to an ambiance of an environment, according to one or more embodiments.

### DETAILED DESCRIPTION

According to aspects of the present disclosure, an electronic device, a method, and a computer program product provides techniques for ambience style adaptation of different portions of an adaptive display device. The device includes a flexible electronic display, that is mounted in a flexible enclosure that enables the display to be bent into a configuration for use in a surface support configuration, such as standing on a desk or table. The device further includes a processor communicatively coupled to the electronic display, and which obtains context data from one or more data sources, wherein the context data is associated with one or more of a user and an environment surrounding the electronic device, and determines a device context. Based on the device context, a customization display theme for the electronic device is loaded, and the customization display theme is presented on the display of the electronic device.

Flexible display technology can enable displays that can be bent, curved, rolled, or otherwise flexed without losing their functionality. Flexible displays are made possible through the use of special materials and manufacturing techniques, and they have a wide range of potential applications in various industries. In one or more embodiments, the flexible displays are comprised of materials that can bend or stretch without breaking. Common materials include organic light-emitting diodes (OLEDs). Organic light-emitting diode displays can be used in disclosed embodiments, and provide the advantage of not requiring a separate backlight, allowing them to be made thinner and more flexible compared to traditional LCD displays. One or more embodiments may utilize Active-Matrix Organic Light-Emitting Diode (AMOLED) displays, which are a type of OLED display with an active-matrix control scheme, enabling improved resolution and response time compared to passive matrix OLEDs.

Flexible display technology enables features of the disclosed embodiments that are not possible on a traditional ‘candy bar’ style of smartphone. The ability for electronic devices to have displays that can fold or curve, provides different visible regions or sections along the display, where one viewer can observe one display region/section while another observer can observe a different display region/section of the same electronic device. The present disclosure takes advantage of this curved or foldable quality of the flexible display to create logical display partitions that separate the regions/sections into different displays for presenting different content. As one aspect of the disclosure, the multiple logical display regions enable disclosed embodiments to provide informational content in one logical display region, while providing non-informational content in another logical display region, and where each logical display region is at a different viewing angle with respect to each other.

The informational content can include presentation of data such as a date, time of day, weather information, stock tickers, video playback, conference calls, health and fitness information, and so on. The non-informational content can include designs, images (including images derived from generative artificial intelligence (AI)), and so on. In one or more embodiments, the non-informational content is selected based on an environment surrounding the electronic device, such as colors of walls, objects in the area, and so on. In one or more embodiments, the non-informational content is selected based on apparel being worn by the user. According to one aspect, electronic devices in accordance with disclosed embodiments can enable ambiance style adaptation of different portions of an adaptive display in a surface display configuration. The surface display configuration can include placing the flexible electronic device on a substantially flat surface such as a desk, table, or counter. In one or more configurations, the electronic device renders an image based on an environment surrounding the electronic device. In one or more embodiments, multiple logical display regions are created in the electronic device, where informational content is displayed on at least one logical display region, and non-informational content, such as a decoration, is displayed on at least one other logical display region. The processor segregates the two different display regions into separate logical display regions, each receiving respective inputs from a graphics processing unit (GPU) rendering the content being displayed. Accordingly, disclosed embodiments can combine functionality with a room décor accessory that adapts to environmental conditions such as surroundings and apparel, and/or other factors such as location, local or national holidays, and so on.

One or more embodiments can include an electronic device including: a flexible electronic display mounted in an enclosure that enables the display to be bent into a configuration for use in a surface support configuration, the configuration visually separating the display into a first display region and a second display region. The electronic device includes at least one image capturing device that captures images within a corresponding field of view and acquires image content. The electronic device further includes a processor communicatively coupled to the at least one image capturing device and the display, and which: obtains, from one or more data sources, context data associated with one or more of a user and an environment surrounding the electronic device; determines a device context based on the context data; loads a customization display theme for the electronic device, based on the device context; and presents the customization display theme on at least one of the first and the second display regions of the display of the electronic device. In one or more embodiments, the configuration is a stand configuration, with a first portion of the display abutting a supporting surface and a second remaining portion of the display extending away from the supporting surface and visible. The processor: logically partitions the first and second portions into corresponding first and second display regions of the display and uses only the second display region for presenting viewable content; and renders and presents the customization display theme on only the second display region of the display.

In one or more embodiments, to determine the device context, the processor identifies characteristics of the environment surrounding the electronic device. The processor then renders, on the electronic display, an image corresponding to one or more of the identified characteristics to at least partially correspond to an ambiance of the environment.

In one or more embodiments, the configuration is a tent configuration, with the first display region corresponding to a first side of the tent configuration and the second display region corresponding to a second side of the tent configuration. The processor, in response to determining that the enclosure is bent in the tent configuration: logically partitions the electronic display into the first display region and the second display region; and separately renders and presents selected content on respective ones of the first display region and the second display region of the display, the selected content including at least the customization display theme presented on at least one of the first or the second display region. In one or more embodiments, the processor enables the electronic device to: output informational content associated with the device context in the first display region; and output non-informational content in the second display region. In one or more embodiments, to output non-informational content in the second display region, the processor initiates a generative artificial intelligence (AI) process that creates an image that is rendered in the second display region. In one or more embodiments, to obtain context data, the processor obtains, from a calendar system, a calendar event associated with the electronic device, wherein the customization display theme is selected based on the calendar event. One or more embodiments can include an audio capturing device communicatively coupled to the processor, and where determining a device context based on the context data is further based on received audio content from the audio capturing device.

In one or more embodiments, a communication interface is provided that enables the electronic device to connect to and transmit instructions to a second electronic device. To determine a device context based on the context data, the processor: transmits the context data (e.g., the preview image(s), location data, etc.) to the second electronic device and also transmits an instruction to the second electronic device to cause the second electronic device to provide the customization display theme to the electronic device; and receives the customization display theme from the second electronic device. The second electronic device, which can be a customization server, in one embodiment, is pre-programmed to respond to a communication of the preview images or other context data with a request for context identification from the first electronic device by performing a search for and retrieval of corresponding image(s) to complete the customization request.

One or more embodiments involves implementation of a method that includes: obtaining, by a processor of an electronic device that comprises a flexible electronic display, context data from one or more data sources, wherein the context data is associated with one or more of a user and an environment surrounding the electronic device. The flexible electronic display is mounted in an enclosure that enables the display to be bent into a configuration for use in a surface support configuration, the configuration visually separating the display into a first display region and a second display region. The method includes: determining a device context based on the context data; loading a customization display theme for the electronic device, based on the device context; and presenting the customization display theme on at least one of the first and the second display regions of the electronic device.

One or more embodiments provide a computer program product that includes a non-transitory computer readable medium having program instructions that when executed by a processor of an electronic device that comprises a flexible electronic display, the program instructions configure the electronic device to perform functions including: obtaining, by the processor, context data from one or more data sources, wherein the context data is associated with one or more of a user and an environment surrounding the electronic device; determining a device context based on the context data; loading a customization display theme for the electronic device, based on the device context; and presenting the customization display theme on the display of the electronic device.

The above descriptions contain simplifications, generalizations and omissions of detail and is not intended as a comprehensive description of the claimed subject matter but, rather, is intended to provide a brief overview of some of the functionality associated therewith. Other systems, methods, functionality, features, and advantages of the claimed subject matter will be or will become apparent to one with skill in the art upon examination of the figures and the remaining detailed written description. The above as well as additional objectives, features, and advantages of the present disclosure will become apparent in the following detailed description.

Each of the above and below described features and functions of the various different aspects, which are presented as operations performed by the processor(s) of the communication/electronic devices are also described as features and functions provided by a plurality of corresponding methods and computer program products, within the various different embodiments presented herein. In the embodiments presented as computer program products, the computer program product includes a non-transitory computer readable storage device having program instructions or code stored thereon, which enables the electronic device and/or host electronic device to complete the functionality of a respective one of the above-described processes when the program instructions or code are processed by at least one processor of the corresponding electronic/communication device, such as is described above.

In the following description, specific example embodiments in which the disclosure may be practiced are described in sufficient detail to enable those skilled in the art to practice the disclosed embodiments. For example, specific details such as specific method orders, structures, elements, and connections have been presented herein. However, it is to be understood that the specific details presented need not be utilized to practice embodiments of the present disclosure. It is also to be understood that other embodiments may be utilized and that logical, architectural, programmatic, mechanical, electrical and other changes may be made without departing from the general scope of the disclosure. The following detailed description is, therefore, not to be taken in a limiting sense, and the scope of the present disclosure is defined by the appended claims and equivalents thereof.

References within the specification to “one embodiment,” “an embodiment,” “embodiments”, or “one or more embodiments” are intended to indicate that a particular feature, structure, or characteristic described in connection with the embodiment is included in at least one implementation (embodiment) of the present disclosure. The appearance of such phrases in various places within the specification are not necessarily all referring to the same embodiment, nor are separate or alternative embodiments mutually exclusive of other embodiments. Further, various features are described which may be exhibited by some embodiments and not by others. Similarly, various aspects are described which may be aspects for some embodiments but not for other embodiments.

The terminology used herein is for the purpose of describing particular embodiments only and is not intended to be limiting of the disclosure. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Moreover, the use of the terms first, second, etc. do not denote any order or importance, but rather the terms first, second, etc. are used to distinguish one element (e.g., a person or a device) from another.

It is understood that the use of specific component, device and/or parameter names and/or corresponding acronyms thereof, such as those of the executing utility, logic, and/or firmware described herein, are for example only and not meant to imply any limitations on the described embodiments. The embodiments may thus be described with different nomenclature and/or terminology utilized to describe the components, devices, parameters, methods and/or functions herein, without limitation. References to any specific protocol or proprietary name in describing one or more elements, features or concepts of the embodiments are provided solely as examples of one implementation, and such references do not limit the extension of the claimed embodiments to embodiments in which different element, feature, protocol, or concept names are utilized. Thus, each term utilized herein is to be provided its broadest interpretation given the context in which that term is utilized.

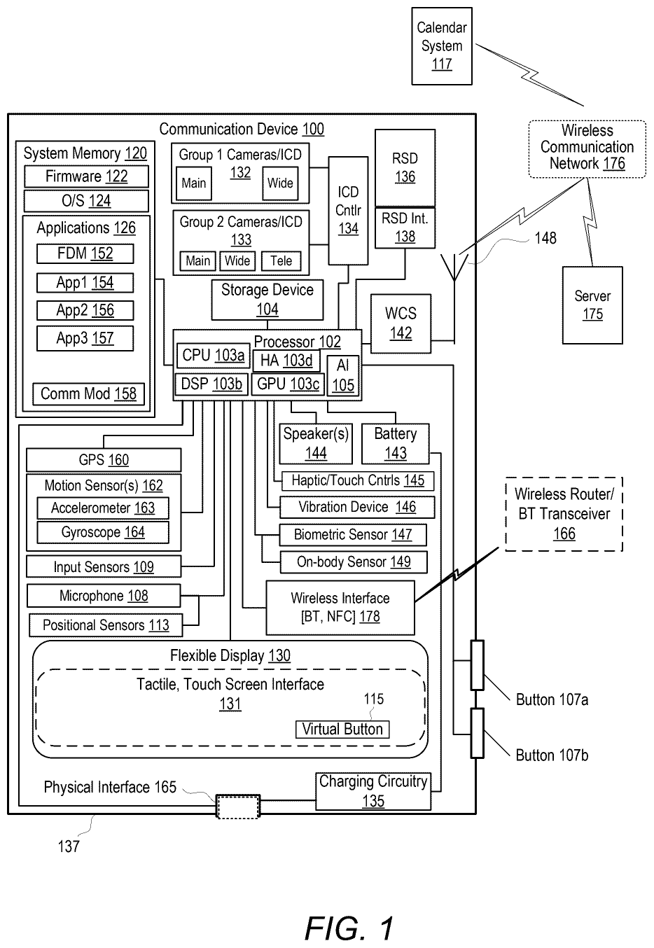

Those of ordinary skill in the art will appreciate that the hardware components and basic configuration depicted in the following figures may vary. For example, the illustrative components within electronic device 100 (FIG. 1) are not intended to be exhaustive, but rather are representative to highlight components that can be utilized to implement the present disclosure. For example, other devices/components may be used in addition to, or in place of, the hardware depicted. The depicted example is not meant to imply architectural or other limitations with respect to the presently described embodiments and/or the general disclosure. Throughout this disclosure, the terms ‘electronic device’, ‘communication device’, and ‘electronic communication device’ may be used interchangeably, and may refer to devices such as smartphones, tablet computers, and/or other computing/communication devices.

Within the descriptions of the different views of the figures, the use of the same reference numerals and/or symbols in different drawings indicates similar or identical items, and similar elements can be provided similar names and reference numerals throughout the figure(s). The specific identifiers/names and reference numerals assigned to the elements are provided solely to aid in the description and are not meant to imply any limitations (structural or functional or otherwise) on the described embodiments.

Referring now to the figures and beginning with FIG. 1, there is illustrated an example component makeup of electronic device 100, within which various aspects of the disclosure can be implemented, according to one or more embodiments. Electronic device 100 includes specific components that enable the device to: identifies a context associated with a user of the electronic device, while the electronic device is being worn by the user; and based on the context, loads and presents a customization display theme on at least an outward facing portion of the display. Examples of electronic device 100 include, but are not limited to, mobile devices, a notebook computer, a mobile phone, a smart phone, a digital camera with enhanced processing capabilities, a smart watch, a tablet computer, and other types of electronic device. It is appreciated that electronic device 100 can include other types of electronic devices that are capable of providing ambiance style adaptation of different portions of an adaptive display device in a surface support configuration.

Electronic device 100 includes processor 102 (typically as a part of a processor integrated circuit (IC) chip), which includes processor resources such as central processing unit (CPU) 103a, communication signal processing resources such as digital signal processor (DSP) 103b, graphics processing unit (GPU) 103c, and hardware acceleration (HA) unit 103d. In some embodiments, the hardware acceleration (HA) unit 103d may establish direct memory access (DMA) sessions to route network traffic to various elements within electronic device 100 without direct involvement from processor 102 and/or operating system 124. Processor 102 can interchangeably be referred to as controller 102.

Controller 102 can, in some embodiments, include image signal processors (ISPs) (not shown) and dedicated artificial intelligence (AI) engines 105. Controller 102 is communicatively coupled to storage device 104, system memory 120, input devices (introduced below), output devices, including integrated flexible display 130, and image capture device (ICD) controller 134. Flexible display 130 is capable of being bent and/or folded to enable a display that can support multiple logical display regions, and where each logical display region has a different viewing angle with respect to other logical display regions on flexible display 130.

According to one or more embodiments, ICD controller 134 performs or supports functions such as, but not limited to, selecting and activating an active camera from among multiple cameras and adjusting the camera settings and characteristics (e.g., shutter speed, f/stop, ISO exposure, zoom control, field of view (FOV) angle, etc.) of the active camera. ICD controller 134 can perform these functions in response to commands received from processor 102 in order to control ICDs 132, 133 to capture video or still images of a local scene within a FOV of the operating/active ICD. Throughout the disclosure, the term image capturing device (ICD) is utilized interchangeably to be synonymous with and/or refer to any one of the cameras 132, 133. Both sets of cameras 132, 133 include image sensors that can capture images that are within the field of view (FOV) of the respective camera 132, 133.

In one or more embodiments, the functionality of ICD controller 134 is incorporated within processor 102, eliminating the need for a separate ICD controller. Thus, for simplicity in describing the features presented herein, the various camera selection, activation, and configuration functions performed by the ICD controller 134 are described as being provided generally by processor 102. Similarly, manipulation of captured images and videos are typically performed by GPU 103c and certain aspects of device communication via wireless networks are performed by DSP 103b, with support from CPU 103a. However, for simplicity in describing the features of the disclosure, the functionality provided by one or more of CPU 103a, DSP 103b, GPU 103c, and ICD controller 134 are collectively described as being performed by processor 102. Collectively, components integrated within processor 102 support computing, classifying, processing, transmitting and receiving of data and information, and presenting of graphical images within a display.

System memory 120 may be a combination of volatile and non-volatile memory, such as random-access memory (RAM) and read-only memory (ROM). System memory 120 can store program code or similar data associated with firmware 122, an operating system 124, and/or applications 126. During device operation, processor 102 processes program code of the various applications, modules, OS, and firmware, that are stored in system memory 120.

In accordance with one or more embodiments, applications 126 include, without limitation, flexible display module (FDM) 152, other applications, indicated as 154, 156 and 157, and communication module 158. Each module and/or application provides program instructions/code that are processed by processor 102 to cause processor 102 and/or other components of electronic device 100 to perform specific operations, as described herein. Descriptive names assigned to these modules add no functionality and are provided solely to identify the underlying features performed by processing the different modules. For example, flexible display module 152 includes program instructions for facilitating ambiance style adaptation of different portions of an adaptive display device in a surface support configuration.

In one or more embodiments, electronic device 100 includes removable storage device (RSD) 136, which is inserted into RSD interface 138 that is communicatively coupled via system interlink to processor 102. In one or more embodiments, RSD 136 is a non-transitory computer program product or computer readable storage device encoded with program code and corresponding data, and RSD 136 can be interchangeably referred to as a non-transitory computer program product. RSD 136 may have a version of one or more of the applications (e.g., 152, 154, 156, 158) and specifically flexible display module 152 stored thereon. Processor 102 can access RSD 136 to provision electronic device 100 with program code that, when executed/processed by processor 102, the program code causes or configures processor 102 and/or generally electronic device 100, to provide the various ambiance style adaptation functions described herein.

Electronic device 100 includes an integrated display 130 which incorporates a tactile, touch screen interface 131 that can receive user tactile/touch input. As a touch screen device, integrated display 130 allows a user to provide input to or to control electronic device 100 by touching features within the user interface presented on display 130. Tactile, touch screen interface 131 can be utilized as an input device. The touch screen interface 131 can include one or more virtual buttons, indicated generally as 115. In one or more embodiments, when a user applies a finger on the touch screen interface 131 in the region demarked by the virtual button 115, the touch of the region causes the processor 102 to execute code to implement a function associated with the virtual button. In some implementations, integrated display 130 is integrated into a front surface of electronic device 100 along with front ICDs, while the higher quality ICDs are located on a rear surface. In one or more embodiments, the flexible display 130 can include materials that can bend or stretch without breaking. These materials can include, but are not limited to, organic light-emitting diodes (OLEDs). Organic light-emitting diode displays can be used in disclosed embodiments. One or more embodiments may utilize Active-Matrix Organic Light-Emitting Diode (AMOLED) displays, which are a type of OLED display with an active-matrix control scheme, enabling improved resolution and response time compared to passive matrix OLEDs. The electronic device 100 may further include a flexible and deformable enclosure, that enables the electronic device 100 to be shaped into a variety of positions for use on a flat surface such as a table, or worn as a wearable electronic device.

Electronic device 100 can further include microphone 108, one or more output devices such as speakers 144, and one or more input buttons, indicated as 107a and 107b. While two buttons are shown in FIG. 1, other embodiments may have more or fewer input buttons. Microphone 108 can also be referred to as an audio input device. In some embodiments, microphone 108 may be used for identifying a user via voiceprint, voice recognition, and/or other suitable techniques. Input buttons 107a and 107b may provide controls for volume, power, and ICDs 132, 133. Additionally, electronic device 100 can include input sensors 109 (e.g., sensors enabling gesture detection by a user). Furthermore, electronic device 100 can include one or more positional sensors 113 that are coupled to one or more linkage members to enable the processor 102 to determine a mode or configuration of the electronic device in terms of how the flexible display 130 is bent or shaped by a user.

Electronic device 100 further includes haptic touch controls 145, vibration device 146, fingerprint/biometric sensor 147, global positioning system (GPS) module 160, and motion sensor(s) 162. Vibration device 146 can cause electronic device 100 to vibrate or shake when activated. Vibration device 146 can be activated during an incoming call or message in order to provide an alert or notification to a user of electronic device 100. According to one aspect of the disclosure, integrated display 130, speakers 144, and vibration device 146 can generally and collectively be referred to as output devices.

Biometric sensor 147 can be used to read/receive biometric data, such as fingerprints, to identify or authenticate a user. In some embodiments, the biometric sensor 147 can supplement an ICD (camera) for user detection/identification. Electronic device 100 can further include on-body sensor 149, which may include a capacitive sensor, electrodermal sensor, or other suitable sensor type to determine when the electronic device 100 is being used as a wearable device

GPS module 160 can provide time data and location data about the physical location of electronic device 100 using geospatial input received from GPS satellites. Motion sensor(s) 162 can include one or more accelerometers 163 and gyroscope 164. Motion sensor(s) 162 can detect movement of electronic device 100 and provide motion data to processor 102 indicating the spatial orientation and movement of electronic device 100. Accelerometers 163 measure linear acceleration of movement of electronic device 100 in multiple axes (X, Y and Z). Gyroscope 164 measures rotation or angular rotational velocity of electronic device 100. Electronic device 100 further includes a housing 137 (generally represented by the thick exterior rectangle) that contains/protects the components internal to electronic device 100.

Electronic device 100 also includes a physical interface 165. Physical interface 165 of electronic device 100 can serve as a data port and can be coupled to charging circuitry 135 and device battery 143 to enable recharging of device battery 143.

Electronic device 100 further includes wireless communication subsystem (WCS) 142, which can represent one or more front end devices (not shown) that are each coupled to one or more antennas 148. In one or more embodiments, WCS 142 can include a communication module with one or more baseband processors or digital signal processors, one or more modems, and a radio frequency (RF) front end having one or more transmitters and one or more receivers. Example communication module 158 within system memory 120 enables electronic device 100 to communicate with wireless communication network 176 and with other devices, such as calendar system 117, which can store events such as national and regional holidays, as well as personal events such as birthdays and anniversaries, as well as server 175 and other connected devices, via one or more of data, audio, text, and video communications. Communication module 158 can support various communication sessions by electronic device 100, such as audio communication sessions, video communication sessions, text communication sessions, exchange of data, and/or a combined audio/text/video/data communication session. In one or more embodiments, server 175 is configured to receive preview image(s) of the field of view of the ICDs 132, 133 of electronic device 100, and to perform analysis and/or computations to provide images corresponding to a customization display theme to the electronic device 100.

WCS 142 and antennas 148 allow electronic device 100 to communicate wirelessly with wireless communication network 176 via transmissions of communication signals to and from network communication devices, such as base stations or cellular nodes, of wireless communication network 176. Wireless communication network 176 further allows electronic device 100 to wirelessly communicate with calendar system 117, server 175, and other communication devices, which can be similarly connected to wireless communication network 176. In one or more embodiments, various functions that are being performed on communications device 100 can be supported using or completed via/on server 175.

Electronic device 100 can also wirelessly communicate, via wireless interface(s) 178, with wireless communication network 176 via communication signals transmitted by short range communication device(s) to and from an external WiFi router (or wireless transceiver device) 180, which is communicatively connected to wireless communication network 176. Wireless interface(s) 178 can be a short-range wireless communication component providing Bluetooth, near field communication (NFC), and/or wireless fidelity (Wi-Fi) connections. In one embodiment, electronic device 100 can receive Internet or Wi-Fi based calls, text messages, multimedia messages, and other notifications via wireless interface(s) 178. In one or more embodiments, electronic device 100 can communicate wirelessly with external wireless device 166, such as a WiFi router or BT transceiver, via wireless interface(s) 178. In an embodiment, WCS 142 with antenna(s) 148 and wireless interface(s) 178 collectively provide wireless communication interface(s) of electronic device 100. The device 100 of FIG. 1 is only a specific example of devices that can be used with embodiments of the present invention. Devices that utilize aspects of the disclosed embodiments can include, but are not limited to, a smartphone, a tablet computer, a laptop computer, a desktop computer, a wearable computer, and/or other suitable electronic device.

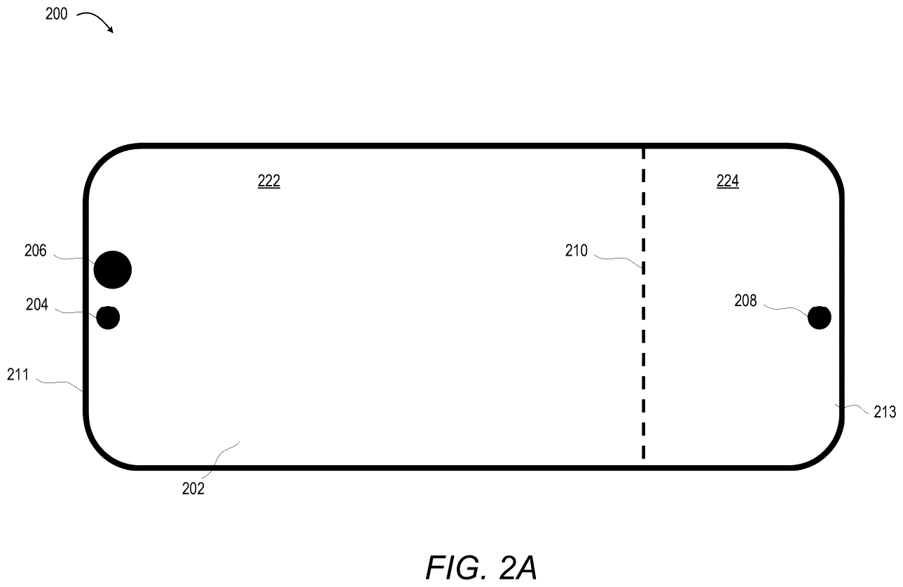

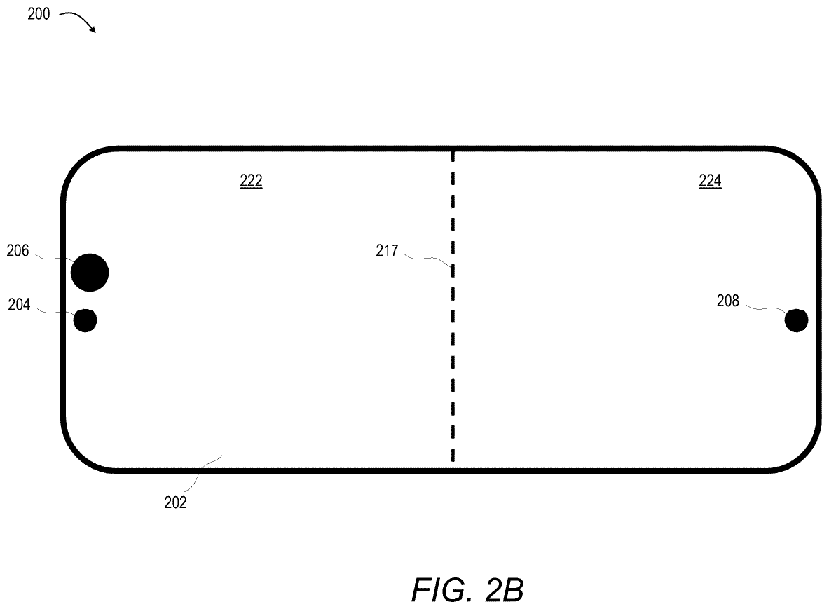

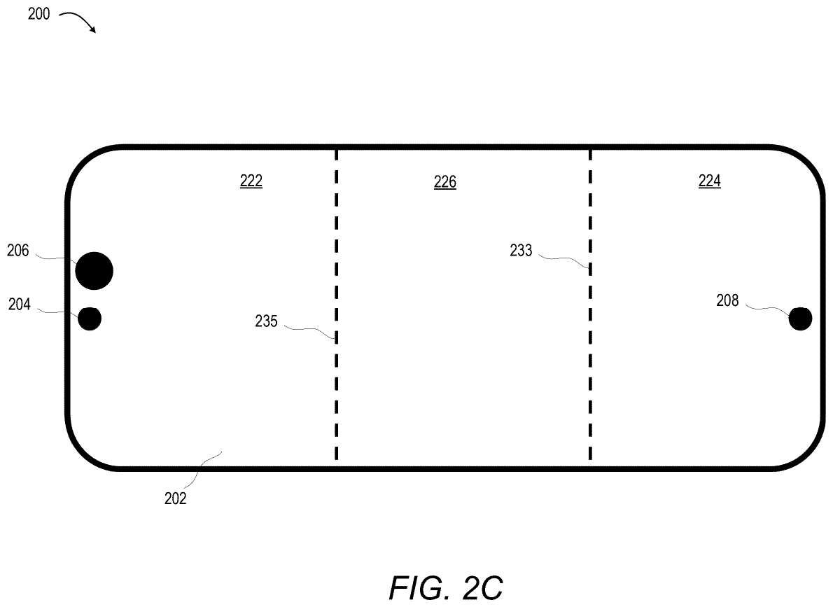

FIG. 2A shows an example display of an electronic device 200 that has been logically partitioned to provide two asymmetrical logical display regions, according to one or more embodiments. Device 200 can be an implementation of electronic device 100, having similar components and/or functionality. Device 200 includes flexible display 202 which is capable of being folded, including being folded along line 210, which fold location is identified by the processor and utilized to separate display 202 into logical display region 222 and logical display region 224. Note that line 210 is a virtual line that indicates where the separation of regions 222 and 224 occurs, but line 210 may not necessarily be rendered or visible on display 202. As can be seen in FIG. 2A, logical display region 222 is larger than logical display region 224. Thus, FIG. 2A depicts asymmetrical logical display partitions. In one or more embodiments, logical display region 222 can be utilized to render non-informational content, while logical display region 224 renders informational content. Alternatively, in one or more embodiments, logical display region 222 is utilized to render informational content, while logical display region 224 renders non-informational content.

Device 200 may include one or more image capturing devices, indicated at 204, 206, and 208. While three image capturing devices are shown on device 200, other embodiments may include more or fewer image capturing devices. Furthermore, while device 200 includes two image capturing devices (204 and 206) near first end 211 and one image capturing device 208 near second end 213, other embodiments may include a different arrangement of image capturing devices. With the integrated image capturing devices, one or more embodiments of the disclosure can include capturing preview images (by the image capturing devices 204, 206, 208) and transmitting received preview image(s) to a second electronic device to cause the second electronic device to provide the customization display theme to the electronic device; and receiving images corresponding to the customization display theme from the second electronic device

FIG. 2B illustrates an example display of an electronic device 200 that has been logically partitioned to provide two symmetrical logical display regions, according to one or more embodiments. Device 200 includes flexible display 202 which is capable of being folded, including being folded along line 217. In response to detecting the fold(s), the processor of electronic device 200 can create logical display region 224. As can be seen in FIG. 2B, logical display region 222 is substantially the same size as logical display region 224. Thus, FIG. 2B depicts symmetrical logical display partitions. In one or more embodiments, logical display region 222 can render non-informational content, while logical display region 224 renders informational content. Alternatively, in one or more embodiments, logical display region 222 renders informational content, while logical display region 224 renders non-informational content.

FIG. 2C shows electronic device 200 configured to include three logical display partitions, according to one or more embodiments. Device 200 includes flexible display 202 which is capable of being folded, including being folded along line 233 and also folded along line 235. In response to detecting the fold(s), the processor of electronic device 200 can create logical display region 222, logical display region 224, and logical display region 226. In one or more embodiments, logical display region 222 and logical display region 224 render non-informational content, while logical display region 226 renders informational content. Other combinations of displaying informational and/or non-informational content within the logical display regions 222, 224, and 226, are possible in various disclosed embodiments. Throughout this disclosure, the term ‘fold’ can include a gradual ‘bend’ (e.g., curving of the display predominantly along a single axis) and/or a more pronounced angle of a fold that creates a crease along a specific line or axis of the display).

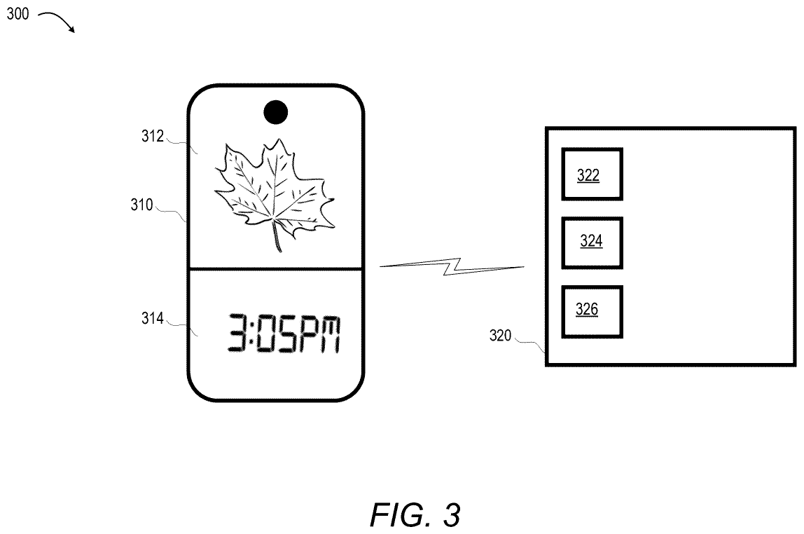

FIG. 3 shows a system 300 that includes a flexible electronic device 310 communicatively coupled to an auxiliary computing device 320, according to one or more embodiments. In one or more embodiments, to enable a foldable and/or wearable form factor of an electronic device that is also deformable, some of the components such as depicted in FIG. 1 may be housed in auxiliary computing device 320. As shown in FIG. 3, flexible electronic device 310 includes a first display region 312 that presents non-informational content, such as a design, and a second display region 314 that displays informational content, such as a time of day. Auxiliary computing device 320 can include a processor 322 that is communicatively coupled to a memory 324 and a communication interface 326. The memory 324 can include a non-transitory computer readable medium that includes instructions executed by processor 322 to perform various functions of one or more embodiments. The communication interface 326 can include a wired and/or wireless communication interface. Accordingly, in one or more embodiments, some computing processes for the electronic device 310 are performed by the auxiliary computing device 320, which communicates with electronic device 310 via communication interface 326. In one or more embodiments, the communication between electronic device 310 and auxiliary computing device 320 is performed via Bluetooth, Bluetooth Low Energy (BLE), and/or other suitable wireless technology. Locating some functionality in the auxiliary computing device 320 allows electronic device 310 to remain light, bendable, and highly configurable, without a loss of processing power. In one or more embodiments, the auxiliary computing device 320 provides some of the processing power for system 300, while the flexible electronic device 310 serves as a content presentation device, wearable device, and/or user interface for the system 300.

In combination, the auxiliary computing device 320 and the flexible electronic device 310 can perform the functions of a conventional electronic device, such as a smartphone. Moreover, the system 300 can work to perform the equivalent functions of any number of other devices as well, including tablet computers, gaming devices, multimedia players, and so on. In one or more embodiments, the auxiliary computing device 320 can be configured as a “puck” or box that can be conveniently carried in a pocket, purse, backpack, and the like. In one or more embodiments, the auxiliary computing device 320 includes a device housing but has no primary display. In these embodiments, the flexible electronic device 310 functions as the primary display for the system 300. Accordingly, disclosed embodiments that utilize an auxiliary computing device enable flexible electronic device 310 to be lighter, enabling more comfort when flexible electronic device 310 is being used as a wearable computing device. One or more embodiments can include transmitting the context data to a second electronic device; transmitting an instruction to the second electronic device to cause the second electronic device to provide the customization display theme to the electronic device; and receiving the customization display theme from the second electronic device.

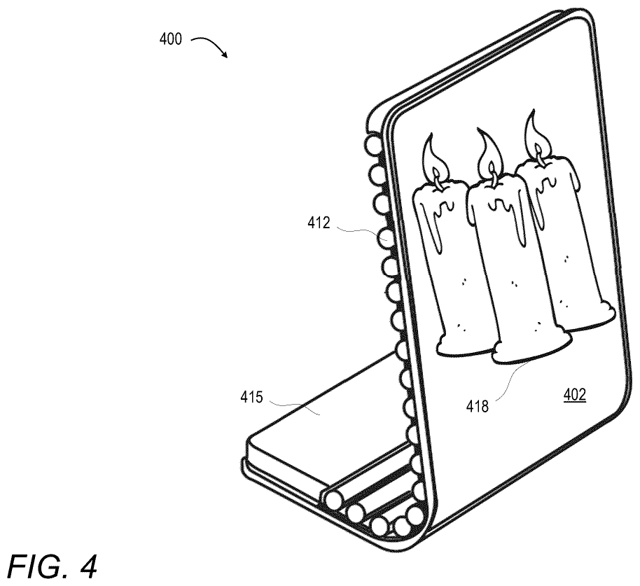

FIG. 4 shows a flexible, deformable, electronic device 400 in a stand configuration, rendering a décor image, according to one or more embodiments. Electronic device 400 can be an implementation of electronic device 100, having similar components and/or functionality. Electronic device 400 includes a deformable housing 415 that includes one or more linkage members, shown generally at 412 that allows the electronic device 400 to be deformable, meaning the electronic device 400 can be bent into a configuration and remains in that configuration until a user changes the configuration by additional bending/unbending. Thus, the electronic device 400 includes a flexible electronic display mounted in a flexible enclosure that enables the display 402 to be bent into a configuration for use as a wearable device, and/or for use in a surface support configuration. The bent configurations visually separate the display into a first display region and a second display region (logical display partitions). In one or more embodiments, integrated positional sensors (e.g., positional sensors 113 of FIG. 1) coupled to the linkage members enable the processor of the electronic device 400 to determine a mode or configuration of the electronic device 400, in terms of the current shape of the display. Thus, in one or more embodiments, the processor can detect when the electronic device is straight, folded, curved, etc.

When flexible electronic device 400 is placed in the stand configuration as shown in FIG. 4, a horizontal or bent lower section of display of the flexible electronic device 400 can be placed on a substantially flat surface such as a desk, table, counter, or the like. In one or more embodiments, the remaining exposed section of the display 402 renders non-informational and/or informational content. As shown in FIG. 4, the display 402 is rendering non-informational content. In particular, the device 400 is shown rendering an image 418 of candles. In one or more embodiments, the image 418 can be a still image such as a digital photograph, illustration, AI-generated image, and so on. In one or more embodiments, the display 402 can render a series of images, such as an animated GIF, and/or a looping video clip. In the example using candles, the animated GIF and/or looping video clip can give the appearance of flickering candles. In one or more embodiments, the image can be based on a calendar event. As an example, a flag image can be shown on national holidays. Embodiments can include obtaining, from a calendar system, a calendar event associated with the electronic device, and selecting the customization display theme based on the calendar event.

In one or more embodiments, a processor within device 400, contributes to the rendering of image 418 and/or the selection process for determining which image is to be rendered on display 402. The selection process can include performing an assessment of an environment surrounding the electronic device 400. The assessment can include acquiring environmental information including, but not limited to, one or more images via onboard cameras (e.g., 132 and 133 of FIG. 1) ambient sounds via onboard microphone (e.g., 108 of FIG. 1), a geographical location via an onboard GPS (e.g., 160 of FIG. 1), and so on. In one or more embodiments, the acquired information is input into an AI engine, and the AI engine generates an output that includes a generative image that is displayed on display 402. Accordingly, in disclosed embodiments, device 400 can serve as a décor element in a room, when configured in a stand configuration as shown in FIG. 4. One or more embodiments can include: identifying characteristics of the environment surrounding the electronic device; and rendering, on the electronic display, an image corresponding to one or more of the identified characteristics to at least partially correspond to an ambiance of the environment. In one or more embodiments, outputting non-informational content in the second display region comprises initiating a generative artificial intelligence (AI) process Athat creates an image that is rendered in the second display region. One or more embodiments can include determining a device context based received audio content from an audio capturing device that is communicatively coupled to the processor.

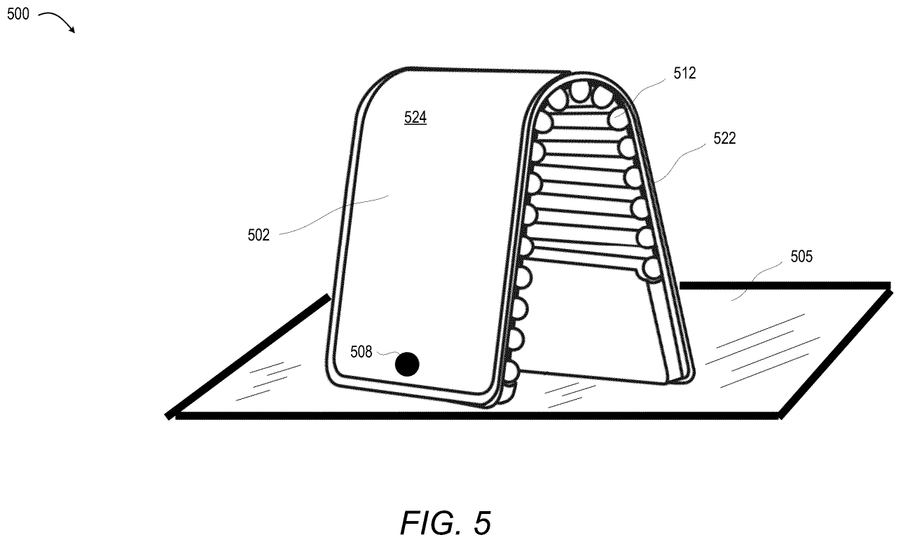

FIG. 5 illustrates a flexible electronic device 500 in a tent configuration, according to one or more embodiments. Electronic device 500 can be an implementation of electronic device 400, having similar components and/or functionality, including one or more linkage members, shown generally at 512 that allows the electronic device 500 to be deformable, whereby the electronic device 500 can be bent into a configuration and remains in that configuration until a user changes the configuration by additional bending/unbending. As shown in FIG. 5, the tent configuration enables the display 502 of flexible electronic device 500 to include a first logical display partition 524 and a second logical display partition 522, which is substantially opposed to first logical display partition 524. In usage, the flexible electronic device 500 may be placed on a substantially flat surface 505 such as a desk, table, counter, or the like. The flexible electronic device 500 may be deformed and placed on the flat surface 505 such that ends (e.g., similar to 211 and 213 shown in FIG. 2A) contact the surface 505, and the resulting device configuration resembling the shape of a “tent.” In the tent configuration, one viewer can be viewing logical display partition 524, while another viewer is simultaneously viewing logical display partition 522. In one or more embodiments, one logical display partition can render informational content, such as a clock, calendar, video, conference call, and the like, while another logical display partition renders non-informational content, such as decorative content including designs and/or images that are selected/generated based on an environment surrounding the electronic device 500. In one or more embodiments, each of logical display partition 522 and logical display partition 524 can present different non-informational content or different informational content, both right side up on respective sides of the tent.

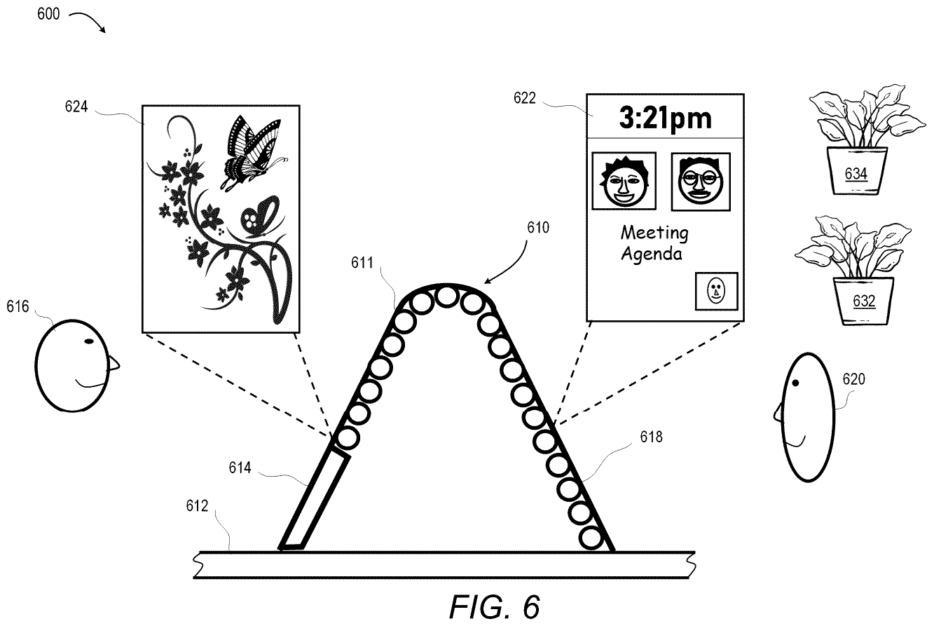

FIG. 6 illustrates an example 600 of usage of a flexible electronic device 610 in a tent configuration, according to one or more embodiments. Electronic device 610 can be an implementation of electronic device 500, having similar components and/or functionality. As shown in FIG. 6, flexible electronic device 610 is placed in a tent configuration on a flat surface 612 such as a table, desk, counter, or the like. In the tent configuration, the display 611 includes first logical display partition 614 and second logical display partition 618. In one or more embodiments, the logical display partition 614 is non-parallel with respect to logical display partition 618. Users in different positions have different views of the logical display partitions. A user 620 is oriented to have a direct line of sight view to second logical display partition 618, while a different user 616 is oriented to have a line-of-sight view to first logical display partition 614. The flexible electronic device 610 can render informational content, which is shown at 622, on logical display partition 618. The informational content 622 can include a time of day, a video conference call rendering, and/or other informational content. Thus, in one or more embodiments, in a tent configuration as shown in FIG. 6, the device 610 can present content viewable from two different directions.

Similarly, flexible electronic device 610 can render non-informational content, which is shown at 624, on first logical display partition 614. and the non-informational content can include a design, photograph, video clip, animation, and/or other non-informational content. In one or more embodiments, an integrated camera (e.g., 508 as shown in FIG. 5), may acquire preview images of one or more items, such as items 632 and 634. As shown in FIG. 6, items 632 and 634 are potted plants. In one or more embodiments, an artificial intelligence (machine learning) process may be executed on flexible electronic device 610 (e.g., dedicated artificial intelligence (AI) engines 105 of FIG. 1) to detect a category and/or classification for items 632 and 634, and to utilized that information to generate the design image shown at 624. That is, based on the detection of items 632 and 634 as potted plants, the flexible electronic device 610 generates a botanical-themed design 624 for display as the non-informational content. Accordingly, user 620 is using the electronic device 610 for a functional purpose of participating in a video conference call, while simultaneously, another user 616 is observing device 610 as a decorative item by viewing the design shown at 624, which is automatically coordinated with the environment surrounding the flexible electronic device 610, where the environment includes one or more items, depicted as 632 and 634. In one or more embodiments, when the electronic device that is in a tent configuration is straightened, one of the two logical displays may be deleted or hidden, and a single, full-screen logical display partition may be shown instead. One or more embodiments can include: logically partitioning the first and second regions of the display for use of the second display region for presenting viewable content; and rendering and presenting the customization display theme on only the second display region of the display.

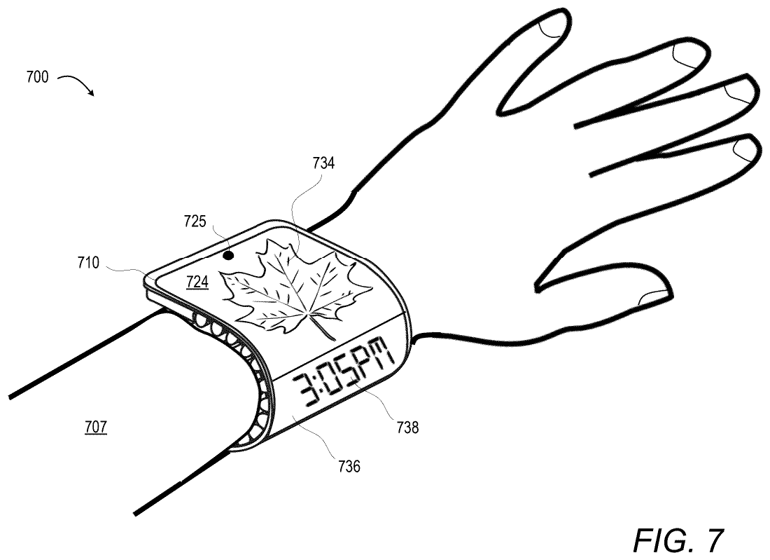

FIG. 7 illustrates a flexible electronic device 700 in a wearable configuration, according to one or more embodiments. Electronic device 700 can be an implementation of electronic device 500, having similar components and/or functionality. As shown in FIG. 7, flexible electronic device 700 is bent in a “C-shape” or circular configuration to enable device 700 to be worn on an arm 707 of a user. In the C-shape or circular configuration, the display 710 includes a first logical display partition 724, and a second logical display partition 736. In one or more embodiments, first logical display partition 724 can include an outward facing portion of the display. As shown in FIG. 7, second logical display partition 736, which faces the user, includes informational content 738, which can include, but is not limited to, time of day, weather information, signal strength information, indications of received messages, and so on, while second logical display partition 724, which faces away from the user and/or is visible by an outside viewer, includes non-informational content, including leaf design 734. In one or more embodiments, onboard camera 725 is used to acquire an image of apparel being worn by the user, by capturing a self-photo (‘selfie’) or scanning the camera's field of view. The detected apparel style, colors, and/or pattern can be used as criteria for selecting and/or generating non-informational content for display in first logical display partition 724. In one or more embodiments, second logical display partition 736 is easily visible to the user wearing the electronic device 700 while first logical display partition 724 is easily visible to other users that are in proximity to the user wearing the electronic device 700. Accordingly, in one or more embodiments, the device 700 can serve as both a fashion accessory, by presenting the design 734 on first logical display partition 724, and as a functional electronic device, by displaying informational content 738, such as time of day, on second logical display partition 736.

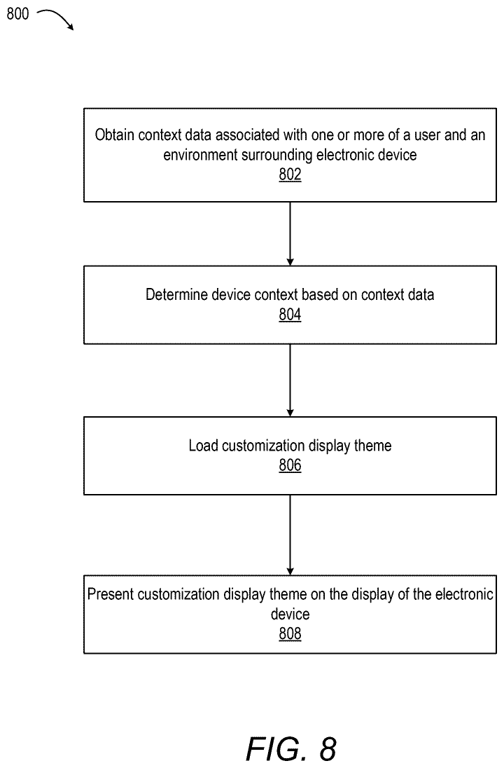

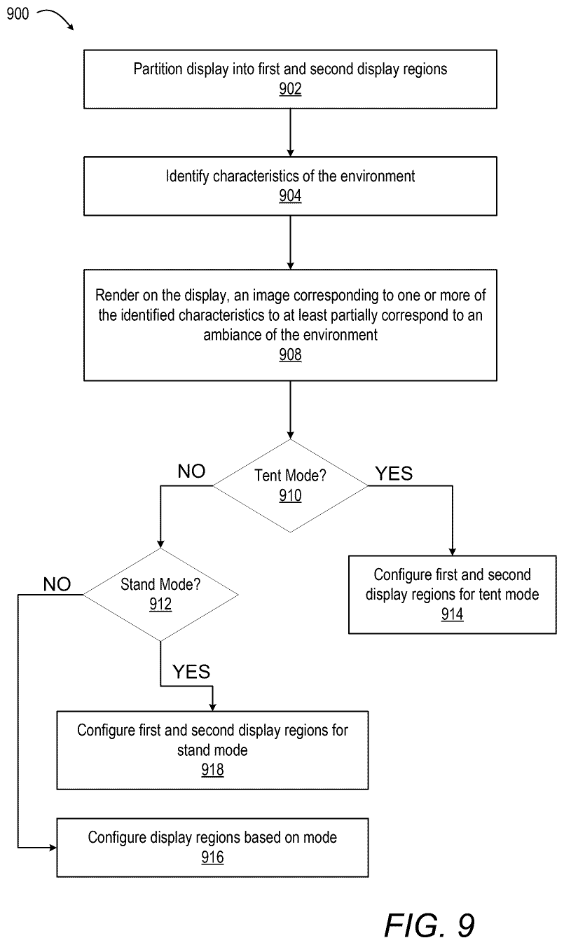

Referring now to the flowcharts presented by FIGS. 8-9, the descriptions of the methods in FIGS. 8-9 are provided with general reference to the specific components and features illustrated within the preceding FIGS. 1-7. Specific components referenced in the methods of FIGS. 8-9 may be identical or similar to components of the same name used in describing preceding FIGS. 1-7. In one or more embodiments, processor 102 (FIG. 1) configures electronic device 100 (FIG. 1) to provide the described functionality of the methods of FIGS. 8-9 by executing program code for one or more modules or applications provided within system memory 120 of electronic device 100.

FIG. 8 depicts a flowchart of a method 800 for presenting a customization display theme on a logically partitioned region of the display of an electronic device based on context data, according to one or more embodiments. The method 800 starts at block 802, where context data associated with one or more of a user and an environment surrounding an electronic device is obtained. The environment can include visual and audio elements. As an example, an image capturing device included in an electronic device can capture images that provide environmental context data. Information in the images, including, but not limited to, colors, patterns, and/or objects can be detected by the electronic device and utilized in determining the device context. In one or more embodiments, an artificial intelligence (AI) engine (e.g., 105 of FIG. 1) can be used to classify objects that appear in an image. As another example, device location data can be received from a location device, such as GPS module 160, and the device's physical location can then be utilized to determine the user and/or device context. As another example, device location data can be determined based on a WiFi network connection (e.g., a home WiFi network), and the user and/or device context can be determined based on the device being in a known location, which can have or be associated with pre-programmed/pre-identified environmental characteristics for context determination. The method 800 continues to block 804 where a device context is determined based on the context data. The method 800 continues with loading a customization display theme 806 on the electronic device. Loading a customization display theme can include creating an image file that is scaled and/or formatted for display on one or more logical display regions of the electronic device. As an example, images that include flowers can cause the electronic device to use the AI engine to create a floral pattern that fits or is fitted into the available area of the display region. The method 800 continues to block 808 with presenting the customization display theme on the display of the electronic device. Accordingly, disclosed embodiments can transform an electronic device into a decorative element of a room, based on environmental information that is acquired from image capturing devices and/or audio capture devices included in the electronic device.

FIG. 9 depicts a flowchart of a method 900 for rendering an image corresponding to identified characteristics that at least partially correspond to an ambiance of an environment, according to one or more embodiments. The method 900 starts with partitioning a display into a first logical display region and a second logical display region at block 902. In one or more embodiments, logical display regions are created based on bends or folds in the electronic device. As an example, folding the electronic device into the ‘tent’ configuration depicted in FIG. 6 can cause two logical displays to be created. The method 900 continues with identifying characteristics of the environment at block 904. The characteristics can include colors, patterns, objects, and/or other environmental information. As an example, an image that includes mountains can be used as a criterion for selecting and/or creating a decorative image to display on the electronic device that at least partially corresponds to the particular mountain environment. Continuing with the example, the decorative image to display can include snowflakes, since snow is often associated with mountains. The method 900 continues with rendering, on the display, an image corresponding to one or more of the identified characteristics to at least partially correspond to an ambiance of the environment at block 908. At block 910, a check is made to determine if the electronic device is in tent mode. If, at block 910, the electronic device is determined to be in tent mode (e.g., such as shown in FIG. 5 and FIG. 7), then the method continues to block 914, where the electronic device configures the first and second display regions for tent mode. If instead, at block 910, the electronic device is determined to not be in tent mode, then the method continues to block 912, where a check is made to determine if the electronic device is in stand mode, such as shown in FIG. 4. If, at block 912 it is determined that the device is in stand mode, then the method 900 continues to block 918, where the first and second display regions are configured for stand mode. In stand mode, the first region can be left blank, without presenting any display content and the second region may show the display content, such that the displayed image appears as a single image to an observer of the second display region, such as image 418 in FIG. 4. If, at block 912, it is determined that the electronic device is not in stand mode, then the method 900 continues to block 916, where the display regions are configured based on the mode, where the mode is neither a stand mode nor a tent mode. As the electronic device of disclosed embodiments is flexible and deformable, a variety of modes are possible, including, but not limited to, surface support modes such as shown in FIG. 4 and FIG. 5 and user wearable modes, such as FIG. 7. One or more of the steps shown in method 800 and/or method 900 may be performed in a different order, performed concurrently, or omitted, in one or more embodiments.

One or more embodiments of the method 900 can include: determining that the enclosure is bent into a tent configuration with the first display region corresponding to a first side of the tent configuration and the second display region corresponding to a second side of the tent configuration; logically partitioning the electronic display into the first display region and the second display region; and separately rendering and presenting selected content on respective ones of the first display region and the second display region of the display, the selected content including at least the customization display theme presented on one of the first or the second display region. One or more embodiments of the method 900 can include: outputting informational content associated with the device context in the first display region; and outputting non-informational content in the second display region.

The customization display theme can include images. The images can be photographs, illustrations, animated GIFs, and so on. The images can be included as wallpapers for a background image for a home screen and/or lock screen of an electronic device. The customization display theme can include font information. The font information can include a font type, font color, font size, and/or font style. The customization display theme can include a user interface theme. For example, the menu theme can include style and/or placement of user interface elements such as dropdown menus, radio buttons, checkboxes, and the like. Other customization display theme elements are possible in disclosed embodiments.

As can now be appreciated, disclosed embodiments provide a flexible, deformable, electronic device that can be bent into one or more configurations that enable logical display partitions that face in different directions. One or more embodiments enable the display of non-informational content in one or more logical display partitions while simultaneously providing informational content in at least one other logical display partition. Thus, one or more embodiments provide a décor accessory that can dynamically change based on user context, while also providing functionality via informational content that is presented to a user of the electronic device.

In the above-described methods, one or more of the method processes may be embodied in a computer readable device containing computer readable code such that operations are performed when the computer readable code is executed on a computing device. In some implementations, certain operations of the methods may be combined, performed simultaneously, in a different order, or omitted, without deviating from the scope of the disclosure. Further, additional operations may be performed, including operations described in other methods. Thus, while the method operations are described and illustrated in a particular sequence, use of a specific sequence or operations is not meant to imply any limitations on the disclosure. Changes may be made with regards to the sequence of operations without departing from the spirit or scope of the present disclosure. Use of a particular sequence is therefore, not to be taken in a limiting sense, and the scope of the present disclosure is defined only by the appended claims.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. Computer program code for carrying out operations for aspects of the present disclosure may be written in any combination of one or more programming languages, including an object-oriented programming language, without limitation. These computer program instructions may be provided to a processor of a general-purpose computer, special-purpose computer, or other programmable data processing apparatus to produce a machine that performs the method for implementing the functions/acts specified in the flowchart and/or block diagram block or blocks. The methods are implemented when the instructions are executed via the processor of the computer or other programmable data processing apparatus.

As will be further appreciated, the processes in embodiments of the present disclosure may be implemented using any combination of software, firmware, or hardware. Accordingly, aspects of the present disclosure may take the form of an entirely hardware embodiment or an embodiment combining software (including firmware, resident software, micro-code, etc.) and hardware aspects that may all generally be referred to herein as a “circuit,” “module,” or “system.” Furthermore, aspects of the present disclosure may take the form of a computer program product embodied in one or more computer readable storage device(s) having computer readable program code embodied thereon. Any combination of one or more computer readable storage device(s) may be utilized. The computer readable storage device may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage device can include the following: a portable computer diskette, a hard disk, a random-access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage device may be any tangible medium that can contain or store a program for use by or in connection with an instruction execution system, apparatus, or device.

Where utilized herein, the terms “tangible” and “non-transitory” are intended to describe a computer-readable storage medium (or “memory”) excluding propagating electromagnetic signals, but are not intended to otherwise limit the type of physical computer-readable storage device that is encompassed by the phrase “computer-readable medium” or memory. For instance, the terms “non-transitory computer readable medium” or “tangible memory” are intended to encompass types of storage devices that do not necessarily store information permanently, including, for example, RAM. Program instructions and data stored on a tangible computer-accessible storage medium in non-transitory form may afterwards be transmitted by transmission media or signals such as electrical, electromagnetic, or digital signals, which may be conveyed via a communication medium such as a network and/or a wireless link.

The description of the present disclosure has been presented for purposes of illustration and description, but is not intended to be exhaustive or limited to the disclosure in the form disclosed. Many modifications and variations will be apparent to those of ordinary skill in the art without departing from the scope of the disclosure. The described embodiments were chosen and described in order to best explain the principles of the disclosure and the practical application, and to enable others of ordinary skill in the art to understand the disclosure for various embodiments with various modifications as are suited to the particular use contemplated.

As used herein, the term “or” is inclusive unless otherwise explicitly noted. Thus, the phrase “at least one of A, B, or C” is satisfied by any element from the set {A, B, C} or any combination thereof, including multiples of any element.

While the disclosure has been described with reference to example embodiments, it will be understood by those skilled in the art that various changes may be made and equivalents may be substituted for elements thereof without departing from the scope of the disclosure. In addition, many modifications may be made to adapt a particular system, device, or component thereof to the teachings of the disclosure without departing from the scope thereof. Therefore, it is intended that the disclosure not be limited to the particular embodiments disclosed for carrying out this disclosure, but that the disclosure will include all embodiments falling within the scope of the appended claims.

What is claimed is:

1. An electronic device comprising:
a flexible electronic display, wherein the flexible electronic display is mounted in an enclosure that enables the display to be bent into a configuration for use in a surface support configuration, the configuration visually separating the display into a first display region and a second display region;
at least one image capturing device that captures images within a field of view and acquires image content; and
a processor communicatively coupled to the at least one image capturing device and the display, and which:
obtains, from one or more data sources, context data associated with one or more of a user and an environment surrounding the electronic device;
determines a device context based on the context data;
loads a customization display theme for the electronic device, based on the device context; and
presents the customization display theme on one of the first and the second display regions of the display of the electronic device.

2. The electronic device of claim 1, wherein:
the configuration is a stand configuration, with a first portion of the display abutting a supporting surface and a second remaining portion of the display extending away from the supporting surface and visible; and
the processor:
logically partitions the first and second portions into corresponding first and second display regions of the display and uses only the second display region for presenting viewable content; and
renders and presents the customization display theme on only the second display region of the display.

3. The electronic device of claim 1, wherein to determine the device context, the processor identifies characteristics of the environment surrounding the electronic device and renders, on the electronic display, an image corresponding to one or more of the identified characteristics to at least partially correspond to an ambiance of the environment.

4. The electronic device of claim 1, wherein:
the configuration is a tent configuration, with the first display region corresponding to a first side of the tent configuration and the second display region corresponding to a second side of the tent configuration; and
the processor, in response to determining that the enclosure is bent into the tent configuration:
logically partitions the electronic display into the first display region and the second display region; and
separately renders and presents selected content on respective ones of the first display region and the second display region of the display, the selected content comprising at least the customization display theme presented on one of the first or the second display region.

5. The electronic device of claim 4, wherein further, the processor enables the electronic device to:
output informational content associated with the device context in the first display region; and
output non-informational content in the second display region.

6. The electronic device of claim 5, wherein to output non-informational content in the second display region, the processor initiates a generative artificial intelligence (AI) process that creates an image that is rendered in the second display region.

7. The electronic device of claim 1, wherein to obtain context data, the processor obtains, from a calendar system, a calendar event associated with the electronic device, wherein the customization display theme is selected based on the calendar event.

8. The electronic device of claim 1, further comprising an audio capturing device communicatively coupled to the processor, and wherein determining a device context based on the context data is further based on received audio content from the audio capturing device.

9. The electronic device of claim 1, further comprising:
a communication interface that enables the electronic device to connect to and transmit instructions to a second electronic device; and
wherein to determine a device context based on the context data, the processor:
transmits the context data to the second electronic device, and also transmits an instruction to the second electronic device to cause the second electronic device to provide the customization display theme to the electronic device; and
receives the customization display theme from the second electronic device.

10. A method comprising:
obtaining, by a processor of an electronic device that comprises a flexible electronic display, wherein the flexible electronic display is mounted in an enclosure that enables the display to be bent into a configuration for use in a surface support configuration, the configuration visually separating the display into a first display region and a second display region, context data from one or more data sources, wherein the context data is associated with one or more of a user and an environment surrounding the electronic device;
determining a device context based on the context data;
loading a customization display theme for the electronic device, based on the device context; and
presenting the customization display theme on the display of the electronic device.

11. The method of claim 10, further comprising:
logically partitions the display into corresponding first and second display regions of the display and uses only the second display region for presenting viewable content; and
rendering and presenting the customization display theme on only the second display region of the display.

12. The method of claim 10, further comprising:
identifying characteristics of the environment surrounding the electronic device; and
rendering, on the electronic display, an image corresponding to one or more of the identified characteristics to at least partially correspond to an ambiance of the environment.

13. The method of claim 10, further comprising:
determining that the enclosure is bent into a tent configuration with the first display region corresponding to a first side of the tent configuration and the second display region corresponding to a second side of the tent configuration; and
logically partitioning the electronic display into the first display region and the second display region; and
separately rendering and presenting selected content on respective ones of the first display region and the second display region of the display, the selected content comprising at least the customization display theme presented on one of the first or the second display region.

14. The method of claim 13, further comprising:
outputting informational content associated with the device context in the first display region; and
outputting non-informational content in the second display region.

15. The method of claim 14, wherein outputting non-informational content in the second display region comprises initiating a generative artificial intelligence (AI) process that creates an image that is rendered in the second display region.

16. The method of claim 10, further comprising:
obtaining, from a calendar system, a calendar event associated with the electronic device, and
selecting the customization display theme based on the calendar event.

17. The method of claim 10, further comprising determining a device context based received audio content from an audio capturing device that is communicatively coupled to the processor.

18. The method of claim 10, further comprising:
transmitting the context data to a second electronic device;
transmitting an instruction to the second electronic device to cause the second electronic device to provide the customization display theme to the electronic device; and
receiving the customization display theme from the second electronic device.

19. A computer program product comprising a non-transitory computer readable medium having program instructions that when executed by a processor of an electronic device that comprises a flexible electronic display, wherein the flexible electronic display is mounted in a flexible enclosure that enables the display to be bent into a configuration for use as a wearable device, and wherein the electronic device includes at least one image capturing device that captures images within a field of view and produces image content, the program instructions configure the electronic device to perform functions comprising:
obtaining, by the processor, context data from one or more data sources, wherein the context data is associated with one or more of a user and an environment surrounding the electronic device;
determining a device context based on the context data;
loading a customization display theme for the electronic device, based on the device context; and
presenting the customization display theme on the display of the electronic device.

20. The computer program product of claim 19, wherein the computer program product further comprises program instructions for:
determining that the enclosure is bent into a tent configuration; and
partitioning the electronic display into a first display region and a second display region, wherein the first display region corresponds to a first side of the tent configuration, and wherein the second display region corresponds to a second side of the tent configuration.
